(19) United States
(12) Patent Application Publication
(10) Pub. No.: US 2009/0316289 A1
(43) Pub. Date: Dec. 24, 2009

(54) MAGNETIC DISK FOR THERMALLY ASSISTED MAGNETIC RECORDING AND MAGNETIC DISK APPLYING THE SAME THEREIN

(75) Inventor: Yasutaka OKURA, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/368,433

(22) Filed: Feb. 10, 2009

(30) Foreign Application Priority Data
Jun. 20, 2008 (JP) 2008-161135

(51) Int. Cl. G11B 5/02

(52) U.S. Cl. 360/59; G9B/5.026

(57) ABSTRACT

A magnetic disk, comprises, a magnetic disk, a disk driving portion for driving the magnetic disk, a slider, mounting thereon a recording element and a reproducing element, for generating a recording magnetic field, and a heating element for use in generation a near field light, and a driver portion for positioning the slide above a desired track of the magnetic disk, wherein the magnetic disk has a recording layer, an overcoat layer formed on the recording layer, a lubricant provided on the overcoat layer, wherein the overcoat layer has a first overcoat film and a second overcoat film, which is formed on the first overcoat film, or has structure of laminating a plural number of overcoat films, and within an inside thereof are provided a plural number of interfaces between different materials and/or grain boundary surfaces.

### BACKGROUND OF THE INVENTION

The present invention relates to a magnetic disk, and in particular, it relates to a magnetic disk for use in thermally assisted magnetic recording, and a magnetic disk applying the same therein, as well.

In recent years, accompanying with tendency of an enlargement of recording capacity and/or an increasing of recording density of a magnetic disk, trials are made on various kinds of technologies, and as one example of them is proposed the thermally assisted magnetic recording, in particular, for the purpose of increasing the recording density thereof.

Within the thermally assisted magnetic recording is applied a recording layer of high magnetic coercive force, wherein as is described in the following Patent Document 1, for example, when recording, the magnetic disk is headed by a near field light, as well as, generation of a magnetic field to be applied, to reduce the magnetic coercive force of the magnetic layer, and thereby conducting the magnetic recording. With the magnetic disk for use of the thermally assisted magnetic recording, an overcoat layer is formed on the recording layer, and on a surface of that overcoat layer is pasted or painted a lubricant.

[Patent Document 1] Japanese Patent No. 3884031.

### BRIEF SUMMARY OF THE INVENTION

Since as the overcoat layer and the lubricant of the magnetic disk for use of the thermally assisted magnetic recording is used a material, having a small optical absorption, then there is no chance that the lubricant is thermally cracked due to direct irradiation of the near field light, or that the lubricant is thermally cracked due to an increase of temperature of the overcoat film.

However, the present inventors find out that the temperature of the recording layer roughly rises from 100° C. to 500° C., lying under the overcoat film, due to heating with the irradiation of the near field light, and that this heat is transmitted to the lubricant, which is painted on the surface of the magnetic disk. Therefore, the lubricant is thermally cracked, or not thermally cracked, but it is evaporated due to the heat, and thereby deteriorating slidability of the magnetic disk. The present invention is accomplished for dissolving such problems.

According to the present invention, the overcoat layer, which is provided on an upper portion of the recording layer of the magnetic disk, has a laminated structure of two (2) layers or more of the overcoat layers, and between the lubricant painted on the overcoat layer is formed an interface layer having high heat resistance, so that the heat when conducting the magnetic recording is hardly transmitted to the lubricant.

According to the present invention, when heating the recording layer of the magnetic disk, which is applied in the thermally assisted magnetic recording, it is possible to protect the lubricant painted on the surface of the magnetic disk from being thermally cracked or evaporated. Also, the heat on the recording layer can hardly run away in the surface direction, and thereby enabling to improve a heating efficiency of the recording layer.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a cross-section block diagram of a magnetic disk, according to the present invention;

FIG. 2 is a view for showing maximum temperature on a disk surface side of an overcoat layer, in comparison with;

FIG. 3 is across-section block diagram of the magnetic disk, according to the present invention;

FIG. 4 is a view for showing maximum temperature on a disk surface side of an overcoat layer, in comparison with;

FIG. 5 is across-section block diagram of the magnetic disk, according to the present invention;

FIG. 6 is a cross-section block diagram of the magnetic disk, according to the present invention;

FIG. 7 is across-section block diagram of the magnetic disk, according to the present invention;

FIG. 8 is across-section block diagram of the magnetic disk, according to the present invention;

FIG. 9 is an entire view of the magnetic disk, according to the present invention; and

FIG. 10 is a cross-section view of a slider portion.

### DETAILED DESCRIPTION OF THE PREFERRED EMBODIMENTS

Hereinafter, embodiments according to the present invention will be fully explained by referring to the drawings attached herewith.

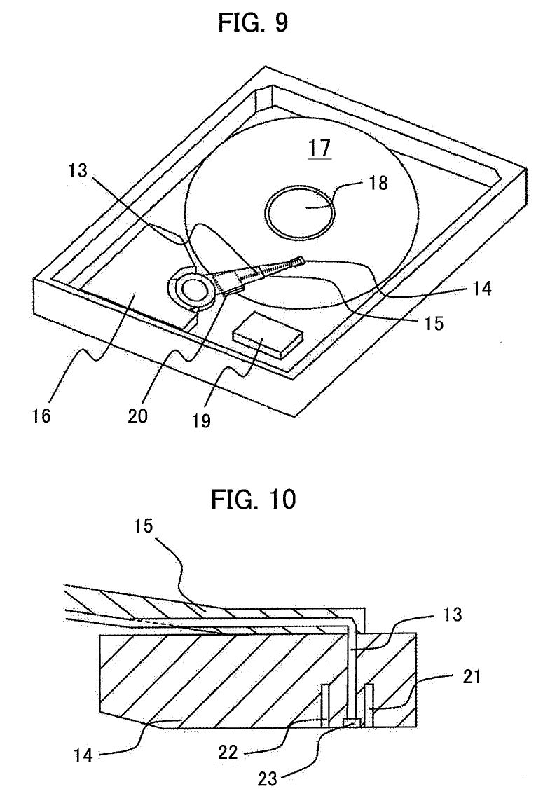

FIG. 9 attached herewith is an outlook view of a magnetic disk apparatus for conducting the thermally assisted magnetic recording therein. This magnetic disk apparatus comprises a magnetic disk 17 according to the present invention, a spindle 18 for rotationally driving the magnetic disk 17, and a slider 14 for mounting a magnetic head thereon. The slider 14 is held by a suspension 15, and it is positioned to a desired track on the magnetic disk, by means of a voice coil motor 16. A recording signal to be sent to the magnetic head or a reproduction signal read out by that magnetic head are processed within a signal processing LSI 119. On to the suspension is fixed a package 20 for a semiconductor laser, and a laser light generated therein is transmitted to the magnetic head through a waveguide 13.

FIG. 10 is a brief cross-section view of the slider portion. On the slider are provided a recording element 21 for generating a recording magnetic field, a reproducing element 22, for reading out information recorded on the magnetic disk 17, such as, a magneto-resistance effect element, etc., for example, and a heating element 23 for generating the near field light. The laser light, which is generated within the package 20 for the semiconductor laser, passes through the waveguide 13 to be irradiated upon the heating element 23. With this, the near field light, which is generated from the heating element 23, locally heats up an area or region on the magnetic disk, to which the recording magnetic field is applied, to reduce the magnetic coercive force, and thereby conducting the magnetic recording.

Hereinafter, explanation will be made on the details of the magnetic disk, according to the present invention.

### Embodiment 1

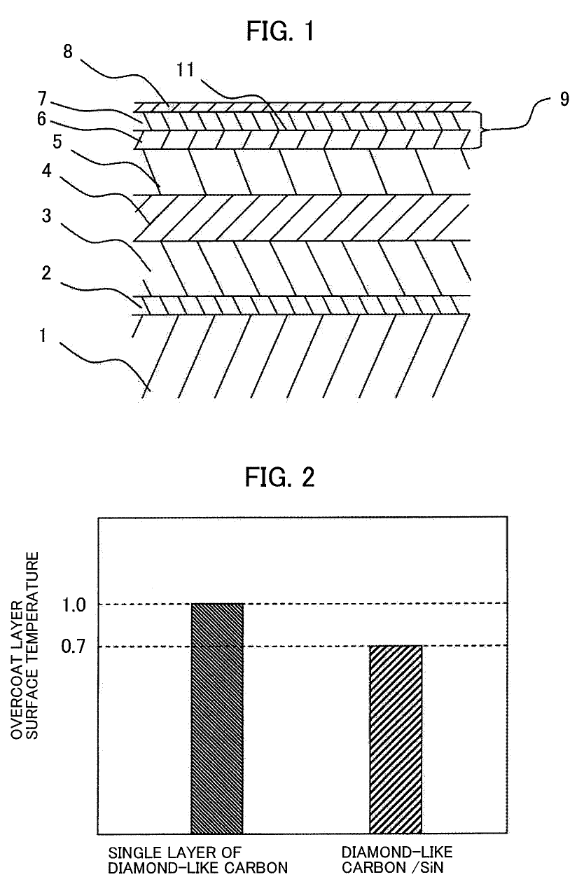

FIG. 1 is a block diagram for showing the cross-section of the magnetic disk, enlargedly, according to a first embodiment of the present invention. With the structures of the magnetic disk according to the present embodiment, on a substrate 1 are laminated an underlayer 2, a soft magnetic underlayer 3, an intermediate layer 4, a recording layer 5 and an overcoat layer 9, sequentially, with using a film forming method, such as, a spattering and/or a chemical vapor deposition method, etc., for example, and a lubricant 8 is painted on the overcoat layer 9. The overcoat layer 9 has laminated structures made up with a first overcoat film 6 and a second overcoat film 7. For the first overcoat film 6 and the second overcoat film 7, preferably, may be applied materials, such as, SiO₂, SiN or a diamond-like carbon, etc., for example, having less optical absorption of the near field light when heating.

As an example, as the first overcoat film 6 is formed a film of SiN with thickness 2 nm, through spattering thereof, and on this is formed a film of the diamond-like carbon with thickness 2 nm, through the spattering thereof, as the second overcoat layer 7, and with this, providing an interface 11 defined between different materials, having a large heat resistance, within the overcoat layer, in parallel with the surface of the magnetic disk. With this, heat on the recording layer 5, generated when recording, can hardly transmits to the lubricant 8, and therefore it is possible to protect the lubricant 8 from the thermal cracking or evaporation thereof.

FIG. 2 is a view for showing the maximum temperature upon the surface of the overcoat layer of the magnetic disk, in comparison between a case where the overcoat layer is constructed with only a single layer of the diamond-like carbon, and a case where it is constructed with two (2) layers of the diamond-like carbon and SiN, similar to the present embodiment. In any case, the thickness of the overcoat layer as a whole is 4 nm, and the recording layer is heated up under the same condition of emitting the laser light. The vertical axis in FIG. 2 indicates an overcoat layer surface temperature, which is normalized by the temperature when constructing the overcoat layer with a single layer of the diamond-like carbon (the results are used where a unit of temperature is ° C.).

As is shown in FIG. 2, even if the thickness of the overcoat layer is same and also is same the energy given to the recording layer, comparing to the case where the overcoat layer is made of only a single layer of only the diamond-like carbon, the maximum temperature of the overcoat layer on the surface side of the magnetic disk is lower than, in case where the overcoat layer is made of the diamond-like carbon and the SiN, and it is possible to prevent the lubricant from being thermally cracked or evaporated. Also, because of such the structure that the heat on the recording layer 5 can hardly run away in the surface direction thereof, it is possible to improve a heating efficiency of the recording layer 5.

Also, since the diamond-like carbon, as the second overcoat film 7 on the surface side, is a material harder than SiN, as the first overcoat film 6 inside, therefore it is possible to obtain a magnetic disk having a high surface strength.

### Embodiment 2

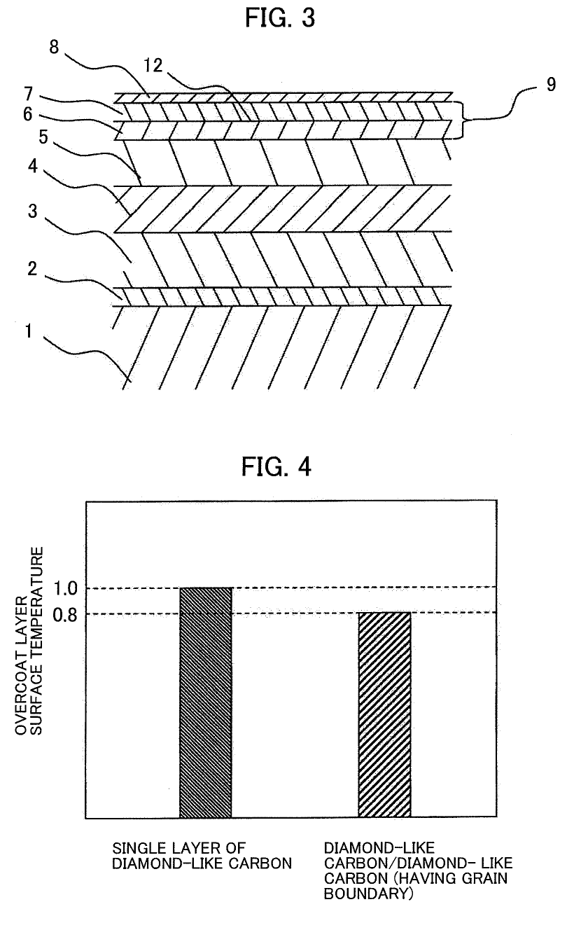

FIG. 3 is a block diagram for enlargedly showing the cross-section of the magnetic disk, according to a second embodiment of the present invention. The magnetic disk of the present embodiment is in the structures of, as is shown in FIG. 3, laminating the underlayer 2, the soft magnetic underlayer 3, the intermediate layer 4, the recording layer 5 and the overcoat layer 9, sequentially, with using a film forming method, such as, a spattering and/or a chemical vapor deposition method, etc., for example, and the lubricant 8 is painted on the overcoat layer 9. The overcoat layer 9 has the structure of laminating the first overcoat layer 6 and the second overcoat layer. According to the present embodiment, a same material is applied to the first overcoat layer 6 and the second overcoat layer 7, but forming a film with changing the condition thereof, and thereby providing a grain boundary surface 12 having a large heat resistance, within the overcoat layer 9, in parallel with the surface of the magnetic disk. As a material of the overcoat layer, preferably, may be applied the materials, such as, SiN and the diamond-like carbon, for example, having less optical absorption of the near field light when heating.

As an example, after forming a film of the diamond-like carbon with thickness 2 nm, through the chemical vapor deposition method, as the first overcoat layer 6, then a film of the diamond-like carbon is formed with thickness 2 nm, through spattering thereof, as the second overcoat layer 7, thereby providing the grain boundary surface 12 having a large heat resistance, within the overcoat layer.

FIG. 4 is a view for showing the maximum temperature upon the surface of the overcoat layer of the magnetic disk, in comparison between a case where the overcoat layer is constructed with only a single layer of the diamond-like carbon, and a case where it is constructed by laminating two (2) layers of the diamond-like carbon, similar to the present embodiment. In any case, the thickness of the overcoat layer as a whole is 4 nm, and the recording layer is heated up under the same condition of emitting the laser light. The vertical axis in FIG. 4 indicates an overcoat layer surface temperature, which is normalized by the temperature when constructing the overcoat layer with a single layer of the diamond-like carbon (the results are used where a unit of temperature is ° C.).

As is shown in FIG. 4, even if the thickness of the overcoat layer is same and also is same the energy given to the recording layer, comparing to the case where the overcoat layer is made of only a single layer of only the diamond-like carbon, the maximum temperature of the overcoat layer on the surface side of the magnetic disk is lower than, in case where the grain boundary surface within the overcoat layer, in the structure of two (2) layers of the diamond-like carbon, and it is possible to prevent the lubricant from being thermally cracked or evaporated. Also, because of such the structure that the heat on the recording layer 5 can hardly run away in the surface direction thereof, it is possible to improve a heating efficiency of the recording layer 5.

### Embodiment 3

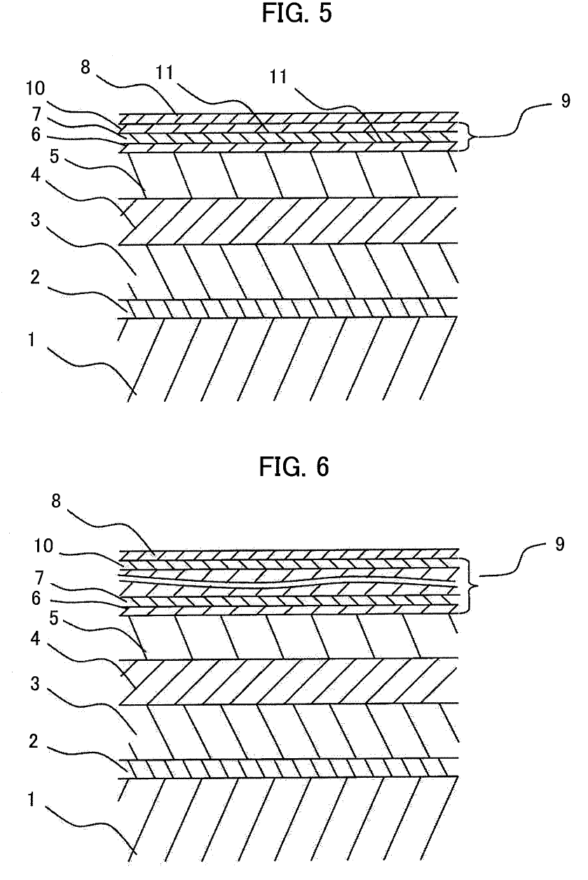

FIG. 5 is a block diagram for showing the cross-section of the magnetic disk, enlargedly, according to a third embodiment of the present invention. With the structures of the magnetic disk according to the present embodiment, on the substrate 1 are laminated the underlayer 2, the soft magnetic underlayer 3, the intermediate layer 4, the recording layer 5 and the overcoat layer 9, sequentially, with using a film forming method, such as, the spattering and/or the chemical vapor deposition method, etc., for example, and the lubricant 8 is painted on the overcoat layer 9. The overcoat layer 9 has three (3)-layers structure, including the first overcoat film 6, the second overcoat film 7, and a third overcoat film 10.

For the first overcoat film 6, the second overcoat film 7 and the third overcoat film 10, to be used as the overcoat layer, preferably, may be applied the materials, such as, SiO₂, SiN or a diamond-like carbon, etc., for example, having less optical absorption of the near field light when heating.

As an example, as the first overcoat film 6 is formed a film of the diamond-like carbon with thickness of 1 nm, through spattering thereof, as the second overcoat film 7 is formed a film of SiN with thickness 1 nm, through the spattering thereof, and as the third overcoat film 10 is formed a film of the diamond-like carbon with thickness 2 nm, through the spattering thereof; thereby providing two (2) interfaces 11 between different materials, within the overcoat layer 9, in parallel with the surface of the magnetic disk. With this, in the similar manner to that in the embodiments 1 and 2, the maximum temperature of the overcoat layer 9 on the surface side of magnetic disk becomes low, and therefore, it is possible to prevent the lubricant 8 from the thermal cracking and/or the evaporation thereof, as well as, to increase the heating efficiency of the recording layer 5.

However, the number of the overcoat films for constructing the overcoat layer should not be limited to three (3), but as is shown in FIG. 6, the overcoat layer 9 may be constructed with four (4) or more of the overcoat films laminated, so as to form (n−1) pieces of the interfaces between different materials having a large heat resistance, within the overcoat layer, and with this structure the similar effect can be obtained. In this case, as the material to be applied to the overcoat layer 9 may be several kinds of different materials, as far as it is a material having less optical absorption of the near field light.

### Embodiment 4

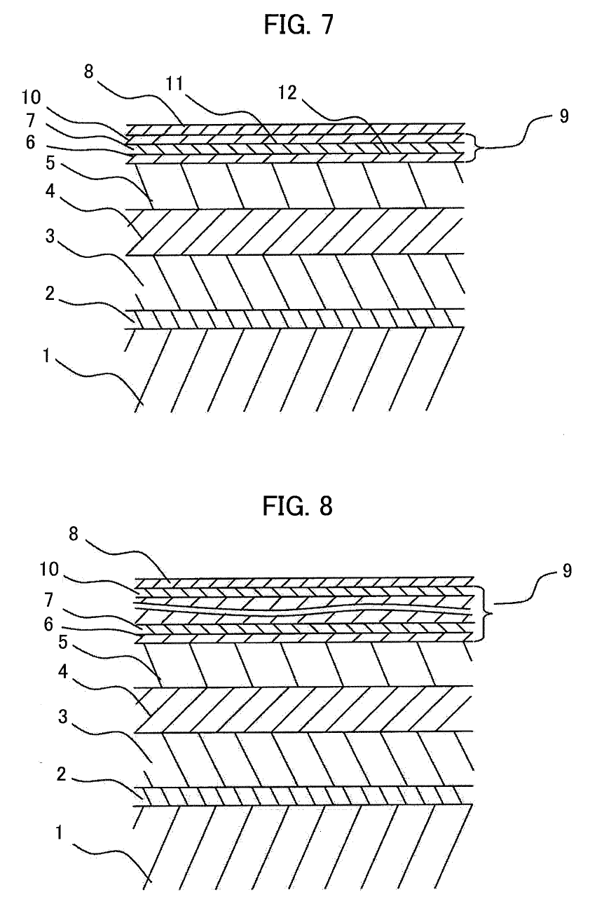

FIG. 7 is a block diagram for showing the cross-section of the magnetic disk, enlargedly, according to a fourth embodiment of the present invention. With the structures of the magnetic disk according to the present embodiment, on the substrate 1 are laminated the underlayer 2, the soft magnetic underlayer 3, the intermediate layer 4, the recording layer 5 and the overcoat layer 9, sequentially, with using a film forming method, such as, the spattering and/or the chemical vapor deposition method, etc., for example, and the lubricant 8 is painted on the overcoat layer 9. The overcoat layer 9 has three (3)-layers structure, including the first overcoat film 6, the second overcoat film 7, and a third overcoat film 10, and has the interface 11 between different materials and the grain boundary surface 12, within the overcoat layer 9, in parallel with the surface of the magnetic disk. For the first overcoat film 6, the second overcoat film 7 and the third overcoat film 10, for building up the overcoat layer, preferably, may be applied the materials, such as, SiO₂, SiN or a diamond-like carbon, etc., for example, having less optical absorption of the near field light when heating.

As an example, as the first overcoat film 6 is formed a film of SiN with thickness 1 nm, through spattering thereof, as the second overcoat film 7 is formed a film of SiN with thickness 1 nm, through the spattering thereof, and as the third overcoat film 10 is formed a film of the diamond-like carbon with thickness 2 nm, through the spattering thereof; thereby providing two (2) interfaces 11 between different materials, within the overcoat layer 9, in parallel with the surface of the magnetic disk. With this, in the similar manner to that in the embodiments 1 and 2, the maximum temperature of the overcoat layer 9 on the surface side of magnetic disk becomes low, and therefore, it is possible to prevent the lubricant 8 from the thermal cracking and/or the evaporation thereof, as well as, increasing the heating efficiency of the recording layer 5.

As an example, as the first overcoat film 6 is formed a film of SiN with thickness of 1 nm, through spattering thereof, and thereon, as the second overcoat film 7 is formed a film of SiN with thickness 1 nm, through the chemical vapor deposition, and further thereon, as the third overcoat film 10 is formed a film of the diamond-like carbon with thickness 2 nm, through the spattering thereof; thereby providing the interface 11 between different materials and the grain boundary surface 12, by one (1) for each, within the overcoat layer 9. With this, in the similar manner to that in the embodiments 1 and 2, the maximum temperature of the overcoat layer 9 on the surface side of magnetic disk becomes low, and therefore, it is possible to prevent the lubricant 8 from the thermal cracking and/or the evaporation thereof, as well as, to increase the heating efficiency of the recording layer 5.

However, the number of the interfaces between different materials or the grain boundary surface, each to be formed within the overcoat layer should not be restricted to one (1), for each, and there may be formed four (4) or more pieces of the overcoat films for building up the overcoat layer 9, and wherein either the grain boundary surface or the interfaces between different materials are formed in plural numbers, or both of them re formed in plural numbers.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A magnetic disk for use in thermally assisted recording, comprising:
a recording layer;
an overcoat layer, which is formed on said recording layer;
a lubricant, which is provided on said overcoat layer, wherein
said overcoat layer has a first overcoat film and a second overcoat film, which is formed on said first overcoat film.

2. The magnetic disk for use in thermally assisted recording, as described in the claim 1, wherein said first overcoat film and said second overcoat film are made of materials different from each other, and further an interface between different materials is provided within said overcoat layer, in parallel with a surface of the magnetic disk.

3. The magnetic disk for use in thermally assisted recording, as described in the claim 1, wherein hardness of said second overcoat film is larger than that of said first overcoat film.

4. The magnetic disk for use in thermally assisted recording, as described in the claim 1, wherein said first overcoat film and said second overcoat film have same composition, and a grain boundary surface is provided within said overcoat layer, in parallel with a surface of the magnetic disk.

5. A magnetic disk for use in thermally assisted recording, comprising:
a recording layer;
an overcoat layer, which is formed on said recording layer;
a lubricant, which is provided on said overcoat layer, wherein
said overcoat layer has structure of laminating a plural number of overcoat films, and within an inside thereof are provided a plural number of interfaces between different materials and/or grain boundary surfaces.

6. A magnetic disk, comprising:
a magnetic disk;
a disk driving portion, which is configured to drive said magnetic disk;
a slider, mounting thereon a recording element and a reproducing element, which are configured to generate a recording magnetic field, and a heating element for use in generation a near field light; and
a driver portion, which is configured to position said slide above a desired track of said magnetic disk, wherein
said magnetic disk, has:
a recording layer;
an overcoat layer, which is formed on said recording layer;
a lubricant, which is provided on said overcoat layer, wherein
said overcoat layer has structure of laminating a plural number of overcoat films, and within an inside thereof are provided a plural number of interfaces between different materials and/or grain boundary surfaces.
